(19) United States
(12) Patent Application Publication
(10) Pub. No.: US 2006/0092797 A1
(43) Pub. Date: May 4, 2006

(54) Optical disk reproducing apparatus

(75) Inventor: Hiroshi Mitsuda, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 11/265,268

(22) Filed: Nov. 3, 2005

(30) Foreign Application Priority Data
Nov. 4, 2004 (JP) P2004-321095

(51) Int. Cl. G11B 5/09

(52) U.S. Cl. 369/53.12; 369/47.11; 369/44.32

(57) ABSTRACT

In performing the balance regulation of focus error signal, the balance of the focus error signal is changed in a predetermined range. Then, the level of the RF signal is measured while continuously changing the balance of the focus error signal and the balance of the focus error signal is changed in a predetermined range when the RF signal level becomes maximum. Then, jitter is measured while changing the focus error signal level. An intermediate balance regulation value between the balance regulation value of the focus error signal when the RF signal level is maximum and the balance regulation value of the focus error signal when the jitter is minimum is calculated. The focus balance regulation is performed by the calculated intermediate balance regulation value.

### BACKGROUND OF THE INVENTION

1. Field of the Invention

The present invention relates to an optical disk reproducing apparatus for reproducing information recorded in an optical disk and, in particular, to a balance regulation of a focus error signal used for a focus servo of an objective lens housed in an optical pickup.

2. Description of the Related Art

It has been usual that an optical disk reproducing apparatus includes an optical pickup having an objective lens for condensing laser beam onto a track of an optical disk, a tracking servo system for performing a tracking control of the objective lens on the basis of a tracking error signal contained in an RF signal from the optical pickup and a focus servo system for performing a focus control of the objective lens on the basis of the focus error signal contained in the RF signal from the optical pickup.

The tracking servo system includes a tracking error detection circuit for detecting a tracking error signal contained in the RF signal from the optical pickup and a tracking drive circuit for outputting a drive signal for driving a tracking actuator for performing a tracking position control of the objective lens on the basis of the detected tracking error signal. The focus servo system includes a focus error detection circuit for detecting the focus error signal contained in the RF signal from the optical pickup and a focus drive circuit for outputting a drive signal for driving a focus actuator for controlling a focus position of the objective lens on the basis of the detected focus error signal.

Incidentally, the focus error signal is changed along a curve in S-lettered shape according to a change of distance from a recording plane of the disk and a position at which the S curve crosses a reference voltage becomes a focused point. The optical pickup includes four optical pickup elements “a,” “b,” “c” and “d.” A first addition signal is produced by a sum of outputs of the optical pickup elements “a” and “c” arranged on a diagonal line, and a second addition signal is produced by a sum of outputs of the optical pickup elements “b” and “d” arranged on the other diagonal line. When the optical pickup is out of focus, there is produced a difference between the first and second addition signals and the difference becomes the focus error signal corresponding to a focus deviation of the optical pickup.

When the optical pickup is out of focus, an upper portion and a lower portion of the S-lettered curve of the focus error signal using the reference voltage as the base becomes asymmetrical. If the focus servo is performed on the basis of such unbalanced S curve, there is a problem that a true focusing cannot be obtained. Therefore, it has been usual in the prior art optical disk reproducing apparatus that the balance regulation of the focus error signal is performed.

The above mentioned technique is disclosed in JP-A-2002-025075 and in JP-A-2001-126261.

### SUMMARY OF THE INVENTION

Therefore, it is usual that, in performing the balance regulation of the focus error signal in the prior optical disk reproducing apparatus, maximum value of the RF signal from the optical pickup is detected and a balance regulation value of the focus error signal corresponding to a point, at which the RF signal is maximum, is used as the balance regulation value of the focus error signal of the optical disk reproducing apparatus. Describing this in more detail with reference to FIG. 2, a value “35” corresponding to a point P at which a value of the RF signal shown by line L1 is maximum is used as the balance regulation value (FBAL) of the focus error signal. Incidentally, the balance regulation value “35” is a value in hexadecimal notation and corresponds to 6% in percentage.

Incidentally, when the optical disk is of 600 μm thick standards, the balance regulation value of the focus error signal corresponding to a point, at which the RF signal becomes maximum, is substantially the same as the balance regulation value of the RF signal corresponding to a point at which jitter becomes minimum (best) . However, the optical disk is of 570 μm to 630 μm thick (600 μm is excluded) standards, the balance regulation value of the focus error signal corresponding to the point, at which the RF signal becomes maximum, may be different from the balance regulation value of the RF signal corresponding to the point at which jitter becomes minimum. In such case, the balance regulation of the focus error signal becomes worse, so that there is a problem that preciseness of focus servo is lowered.

In the prior art technique disclosed in JP-A-2002-025075, the balance regulation of focus error signal is performed at a point, at which jitter becomes minimum. However, since the jitter curve is gentler than the RF signal curve (see FIG. 2), it can not be said that preciseness of balance regulation of the focus error signal is improved by using only jitter having such characteristics.

The prior art technique disclosed in JP-A-2001-126261 optimizes jitter without intercepting reproduction when a CLV disk is CAV-reproduced or a warped disk is reproduced. However, there is no countermeasure disclosed against improvement of preciseness of balance regulation of the focus error signal.

The present invention provides an optical disk reproducing device capable of improving preciseness of a focus servo by improving balance regulation of a focus error signal.

According to a first aspect of the invention, there is provided an optical disk reproducing apparatus that reproduces information recorded on an optical disk, including: an optical pickup that optically reads information recorded on the optical disk and outputs an RF signal; and a system controller. The system controller includes: a first focus error balance changing unit that changes balance of a focus error signal contained in the RF signal in a predetermined range; an RF level measuring unit that measures level of the RF signal while the balance of the focus error signal is changed; an RF level determination unit that determines a maximum value of the level of the RF signal while the level of the RF signal is measured; a second focus error balance changing unit that changes balance of the focus error signal in a predetermined range when the level of the RF signal is determined to be maximum; a jitter measuring unit that measures jitter while the balance of the focus error signal is changed; and a balance regulation value calculation unit that calculates a balance regulation value that is intermediate between a value of the balance of the focus error signal when the level of the RF signal is determined to be maximum and a value of the balance of the focus error signal when jitter is measured to be minimum. The system controller performs a focus servo based on a focus error signal obtained from the balance regulation value.

According to a second aspect of the invention, there is provided an optical disk reproducing apparatus that reproduces information recorded on an optical disk, including: an optical pickup that optically reads information recorded on the optical disk and outputs an RF signal; and a system controller that measures level and jitter of an RF signal while changing balance of a focus error signal contained in the RF signal, calculates a balance regulation value that is intermediate between a value of the balance of the focus error signal when the level of the RF signal is maximum and a value of the balance of the focus error signal when the jitter of the RF signal is minimum, and performs a focus servo based on a focus error signal obtained from the balance regulation value.

### BRIEF DESCRIPTION OF THE DRAWINGS

In the accompanying drawings:

FIG. 1 is a block diagram showing a configuration of an optical disk reproducing apparatus according to an embodiment;

FIG. 2 shows a level change of an RF signal when balance of focus error signal is changed in the embodiment and a change of jitter when balance of focus error signal is changed in the embodiment; and

FIG. 3 is a flowchart showing a processing in performing balance regulation of the focus error signal in the embodiment.

### DETAILED DESCRIPTION OF THE PREFERRED EMBODIMENT

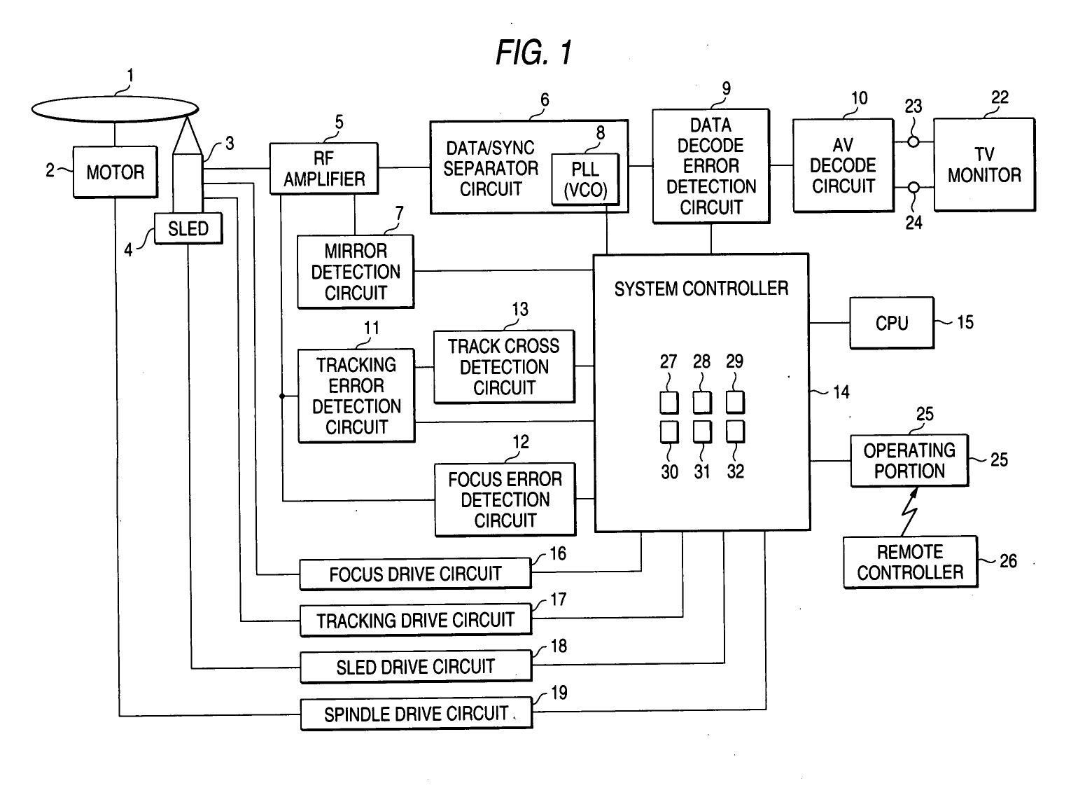

An embodiment of the present invention will be described with reference to the attached drawings. FIG. 1 is a block circuit diagram showing a configuration of the optical disk reproducing apparatus according to an embodiment of the present invention.

In FIG. 1, the optical disk reproducing apparatus includes an optical pickup 3 for emitting laser light for reproducing information recorded on an optical disk 1 such as DVD and receiving reflection light from the optical disk 1, a spindle motor 2 for rotating the optical disk 1, a spindle drive circuit 19 for driving the spindle motor 2, a tracking drive circuit 17 for driving a tracking servo actuator (not shown) performing a tracking servo of the optical pickup 3, a focus drive circuit 16 for driving a focus servo actuator (not shown) performing a focus servo of the optical pickup 3, a sled 4 for moving the optical pickup 3 in a radial direction of the optical disk 1 and a sled drive circuit 18 for driving the sled 4.

Further, the optical disk reproducing apparatus includes an RF amplifier 5 for amplifying an RF signal from the optical disk 1 during reproduction of the optical disk 1, a data/sync signal separator circuit 6 having a PLL (phase locked loop) 8 including a VCO (voltage controlled oscillator), for separating the RF signal from the RF amplifier 5 to data and a sync signal, a data decode error correction circuit 9 for checking error by inputting and decoding the data separated by the data/sync signal separator circuit 6 and, when there is an error in the data, outputting a correct data by correcting the data and an AV decode circuit 10 for inputting and decoding the correct data from the data decode error correction circuit 9 and supplying an audio signal and a video signal to, for example, a TV monitor 22 through a video output terminal 23 and an audio output terminal 24 thereof, respectively.

Further, the disk reproducing device includes a mirror detection circuit 7 for detecting a mirror signal contained in the RF signal from the RF amplifier 5 and indicative of mirror surfaces of the optical disk 1, in which there is no track, and counting the mirror surfaces, a tracking error detection circuit 11 for detecting a tracking error signal contained in the RF signal from the optical pickup 3 through the RF amplifier 5, a focus error detection circuit 12 for detecting a focus error signal contained in the RF signal from the optical pickup 3 through the RF amplifier 5, a track cross detection circuit 13 for outputting track pulses by detecting track crosses on the basis of the tracking error signal from the tracking error detection circuit 11 and a memory 20 for storing data necessary for the processing of the system controller 14.

Further, the optical disk reproducing apparatus includes an operation unit 25 having a plurality of keys provided on a front panel of the device body for performing ON/OFF operation of a power source of the device and various operations related to the reproducing operation of the device. The operation unit 25 includes light receiving means (not shown) for receiving optical signal indicative of operational instructions from a remote controller 26. The light receiving means converts an optical signal into an electric signal and supplies the electric signal to the system controller 14 as the instruction signal. The remote controller 26 includes a plurality of keys (not shown) for ON/OFF operation of the power source of the device and various operations related to the reproducing operation of the device.

Further, the optical disk reproducing apparatus includes the system controller 14 for controlling the above mentioned various constructive components according to a CPU 15, which performs the processing of the whole device. The system controller 14 performs a focus servo control of the optical pickup 3 on the basis of the focus error signal contained in the RF signal from the optical pickup 3, a tracking servo control of the optical pickup 3 on the basis of the tracking error signal contained in the RF signal from the optical pickup 3, a control for moving the optical pickup 3 in the radial direction of the optical disk 1 by driving the sled 4 through the sled drive circuit 18 in order to determine a reproducing position of the optical disk 1 according to reproduction instruction signals from the operation unit 25 or the remote controller 26 and a control for rotating the spindle motor 2 through the spindle drive circuit 19 according to the operation signals from the operation unit 25 or the remote controller 26, etc.

Further, the system controller 14 includes a first focus error balance changing unit 27 for changing balance of the focus error signal contained in the RF signal from the optical pickup 3 in a predetermined range, an RF level measuring unit 28 for measuring level of the RF signal while changing the balance of the focus error signal, an RF level determination unit 29 for determining maximum level of the RF signal while measuring the level of the RF signal, a second focus error balance changing unit 30 for changing the balance of the focus error signal in a predetermined range when the level of the RF signal becomes maximum, a jitter measuring unit 31 for measuring jitter while changing the balance of the focus error signal and a balance regulation calculation unit 32 for calculating an intermediary balance regulation value between the balance regulation value of the focus error signal when the level of the RF signal is maximum and the balance regulation value of the focus error signal when the jitter is minimum.

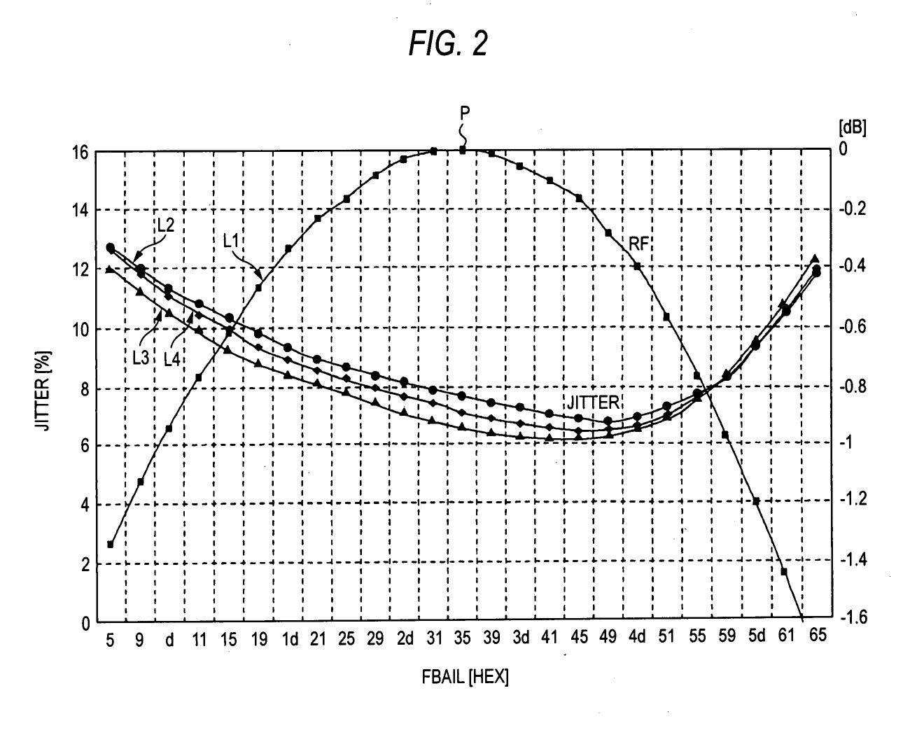

FIG. 2 shows graphs of level change of the RF signal when the balance of the focus error signal is changed and a jitter change when the balance of the focus error signal is changed in the embodiment. In FIG. 2, L1 is a line showing the level change of the RF signal. L2 is a line showing a rising level change of jitter, L3 is a line showing a falling level change of jitter and L4 is a line showing rising and falling level change of jitter.

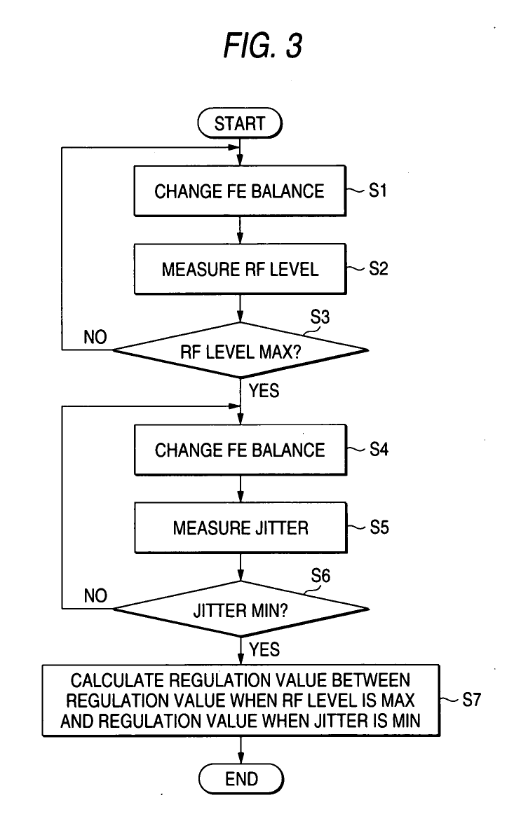

FIG. 3 is a flowchart showing a processing in performing the balance regulation of the focus error signal in the embodiment. The processing in performing the balance regulation of the focus error signal will be described with reference to this flowchart.

In performing the balance regulation of the focus error signal, the balance of the focus error signal is changed in a predetermined range (for example, ±7%) by the first focus error balance changing unit 27 (Step S1). As mentioned previously, when the focus point of the optical pickup 3 is deviated, a difference appears between a first sum signal, which is a sum of the outputs of the optical pickup elements “a” and “c,” and a second sum signal, which is a sum of the outputs of the optical pickup elements “b” and “d.” This difference becomes the focus error signal corresponding to the focus deviation of the optical pickup 3. The balance regulation of this focus error signal is performed by a gain regulator (not shown) provided in the RF amplifier 5. By changing the gain by the gain regulator, it is possible to change the balance of the focus error signal in the predetermined range (for example, ±7%).

Then, the level of the RF signal is measured by the RF level measuring unit 28 while continuously changing the balance of the focus error signal (Step S2). This measurement is performed while storing measuring results of the RF signal level in the memory 20. During the measurement of the RF signal level, it is determined by the RF level determination unit 29 whether or not the level of the RF signal becomes maximum (Step S3) and, when the level of the RF signal becomes maximum (for example, point P in FIG. 2), the balance of the focus error signal is changed in a predetermined range (for example, FBAL 15 to 55 (HEX) in FIG. 2) by the second focus error balance changing unit 30 (Step S4).

Next, jitter is measured by the jitter measuring unit 31 while changing the focus error signal level in the predetermined range (for example, FBAL 15 to 55 (HEX)) (Step S5). This measurement of jitter is performed while storing measuring results of the jitter in the memory 20. When the jitter is minimum during the jitter measurement (Step S6) , the balance regulation value of the focus error signal when the RF signal level is maximum (for example, FBAL 35 (HEX) in FIG. 2) and the balance regulation value of the focus error signal when the jitter is minimum (for example, FBAL 45 (HEX) in FIG. 2) are temporarily stored in the memory 20 and the balance regulation value (for example, FBAL 3d (HEX) in FIG. 2) between the balance regulation value of the focus error signal when the RF signal level is maximum (for example, FBAL 35 (HEX)) and the balance regulation value of the focus error signal when the jitter is minimum (for example, FBAL 45 (HEX)) is calculated by the balance regulation calculation unit 32 (Step S7).

Converting unit (HEX) of the balance regulation value of the focus error signal into percentage, 35 (HEX) corresponds to 6%, 45 (HEX) is 10% and 3d (HEX) is 8%. Since, therefore, the focus balance regulation is performed by the intermediate balance regulation value (8%) between the focus error signal balance regulation value (6%) when the RF signal level is maximum and the focus error signal balance regulation value (10%) when the jitter is minimum, the balance regulation of focus error signal is improved and the preciseness of focus servo is improved. As a result, it is possible to obtain highly precise reproducing signal.

As described in detail with reference to the embodiment, there is provided an optical disk reproducing apparatus that reproduces information recorded on an optical disk, including: an optical pickup that optically reads information recorded on the optical disk and outputs an RF signal; and a system controller. The system controller includes: a first focus error balance changing unit that changes balance of a focus error signal contained in the RF signal in a predetermined range an RF level measuring unit that measures level of the RF signal while the balance of the focus error signal is changed; an RF level determination unit that determines a maximum value of the level of the RF signal while the level of the RF signal is measured; a second focus error balance changing unit that changes balance of the focus error signal in a predetermined range when the level of the RF signal is determined to be maximum; a jitter measuring unit that measures jitter while the balance of the focus error signal is changed; and a balance regulation value calculation unit that calculates a balance regulation value that is intermediate between a value of the balance of the focus error signal when the level of the RF signal is determined to be maximum and a value of the balance of the focus error signal when jitter is measured to be minimum. The system controller performs a focus servo based on a focus error signal obtained from the balance regulation value.

In the above configuration, in regulating balance of the focus error signal, the balance of the focus error signal is changed in the predetermined range by the first focus error balance changing unit. The level of the RF signal while changing the balance of the focus error signal is measured while changing the balance of the focus error signal by the RF level measuring unit and the RF level determination unit determines maximum level of the RF signal. When the RF signal becomes maximum, the second focus error balance changing unit changes balance of the focus error signal in the predetermined range.

Next, jitter is measured by the jitter measuring unit while changing balance of the focus error signal and an intermediary balance regulation value between a balance regulation value of the focus error signal when the level of the RF signal is maximum and a balance regulation value of the focus error signal when the jitter is minimum is calculated by the balance regulation value calculation unit. The focus servo is performed by a focus error signal obtained from the intermediary balance regulation value thus calculated.

According to the above configuration, since the focus balance regulation is performed by the intermediary balance regulation value between the balance regulation value of the focus error signal when the level of the RF signal is maximum and the balance regulation value of the focus error signal when the jitter is minimum, the balance regulation of the focus error signal is improved and preciseness of the focus servo is improved. Thus, it is possible to obtain highly precise reproduction signal.

There is also provided an optical disk reproducing apparatus that reproduces information recorded on an optical disk, including: an optical pickup that optically reads information recorded on the optical disk and outputs an RF signal; and a system controller that measures level and jitter of an RF signal while changing balance of a focus error signal contained in the RF signal, calculates a balance regulation value that is intermediate between a value of the balance of the focus error signal when the level of the RF signal is maximum and a value of the balance of the focus error signal when the jitter of the RF signal is minimum, and performs a focus servo based on a focus error signal obtained from the balance regulation value.

In the above configuration, the focus servo is performed by a focus error signal obtained by measuring level of the RF signal and jitter while changing balance of a focus error signal contained in the RF signal from the optical pickup, calculating the intermediary balance regulation value between the balance regulation value of the focus error signal when the level of the RF signal is maximum and the balance regulation value of the focus error signal when the jitter is minimum.

According to this configuration, since the focus balance is regulated by the intermediary balance regulation value between the balance regulation value of the focus error signal when the level of the RF signal is maximum and the balance regulation value of the focus error signal when the jitter is minimum, the balance regulation of the focus error signal is improved and preciseness of the focus servo is improved. Thus, it is possible to obtain highly precise reproduction signal.

In the above configuration, the system controller may be configured to include: a first focus error balance changing unit that changes balance of a focus error signal contained in the RF signal in a predetermined range; an RF level measuring unit that measures level of the RF signal while the balance of the focus error signal is changed; an RF level determination unit that determines a maximum value of the level of the RF signal while the level of the RF signal is measured; a second focus error balance changing unit that changes balance of the focus error signal in a predetermined range when the level of the RF signal is determined to be maximum; a jitter measuring unit that measures jitter while the balance of the focus error signal is changed; and a balance regulation value calculation unit that calculates a balance regulation value that is intermediate between a value of the balance of the focus error signal when the level of the RF signal is determined to be maximum and a value of the balance of the focus error signal when jitter is measured to be minimum.

According to the above configuration, it is possible to regulate the focus balance by the intermediary balance regulation value between the balance regulation value of the focus error signal when the level of the RF signal is maximum and the balance regulation value of the focus error signal when the jitter is minimum.

According to the configurations described above, it is possible to regulate the focus balance by the intermediary balance regulation value between the balance regulation value of the focus error signal when the level of the RF signal is maximum and the balance regulation value of the focus error signal when the jitter is minimum. Therefore, the balance regulation of the focus error signal is improved and preciseness of the focus servo is improved. Thus, it is possible to obtain highly precise reproduction signal.

Although the present invention has been shown and described with reference to the embodiment, various changes and modifications will be apparent to those skilled in the art from the teachings herein. Such changes and modifications as are obvious are deemed to come within the spirit, scope and contemplation of the invention as defined in the appended claims.

What is claimed is:

1. An optical disk reproducing apparatus that reproduces information recorded on an optical disk, comprising:
an optical pickup that optically reads information recorded on the optical disk and outputs an RF signal; and
a system controller that includes:
a first focus error balance changing unit that changes balance of a focus error signal contained in the RF signal in a predetermined range;
an RF level measuring unit that measures level of the RF signal while the balance of the focus error signal is changed;
an RF level determination unit that determines a maximum value of the level of the RF signal while the level of the RF signal is measured;
a second focus error balance changing unit that changes balance of the focus error signal in a predetermined range when the level of the RF signal is determined to be maximum;
a jitter measuring unit that measures jitter while the balance of the focus error signal is changed; and
a balance regulation value calculation unit that calculates a balance regulation value that is intermediate between a value of the balance of the focus error signal when the level of the RF signal is determined to be maximum and a value of the balance of the focus error signal when jitter is measured to be minimum,
wherein the system controller performs a focus servo based on a focus error signal obtained from the balance regulation value.

2. An optical disk reproducing apparatus that reproduces information recorded on an optical disk, comprising:
an optical pickup that optically reads information recorded on the optical disk and outputs an RF signal; and
a system controller that measures level and jitter of an RF signal while changing balance of a focus error signal contained in the RF signal, calculates a balance regulation value that is intermediate between a value of the balance of the focus error signal when the level of the RF signal is maximum and a value of the balance of the focus error signal when the jitter of the RF signal is minimum, and performs a focus servo based on a focus error signal obtained from the balance regulation value.

3. The optical disk reproducing apparatus according to claim 2, wherein the system controller includes:
a first focus error balance changing unit that changes balance of a focus error signal contained in the RF signal in a predetermined range;
an RF level measuring unit that measures level of the RF signal while the balance of the focus error signal is changed;
an RF level determination unit that determines a maximum value of the level of the RF signal while the level of the RF signal is measured;
a second focus error balance changing unit that changes balance of the focus error signal in a predetermined range when the level of the RF signal is determined to be maximum;
a jitter measuring unit that measures jitter while the balance of the focus error signal is changed; and
a balance regulation value calculation unit that calculates a balance regulation value that is intermediate between a value of the balance of the focus error signal when the level of the RF signal is determined to be maximum and a value of the balance of the focus error signal when jitter is measured to be minimum.
